(19) United States
(12) Patent Application Publication
(10) Pub. No.: US 2014/0062640 A1
(43) Pub. Date: Mar. 6, 2014

(54) Surface-Mount Inductor

(71) Applicants: Kunio Sasamori, Higashimatsuyama (JP); Masaaki Totsuka, Tsurugashima-shi (JP); Yasuyuki Kawauchi, Tsurugashima-shi (JP); Keita Muneuchi, Shiki-shi (JP); Hiroyasu Mori, Kawagoe-shi (JP)

(72) Inventors: Kunio Sasamori, Higashimatsuyama (JP); Masaaki Totsuka, Tsurugashima-shi (JP); Yasuyuki Kawauchi, Tsurugashima-shi (JP); Keita Muneuchi, Shiki-shi (JP); Hiroyasu Mori, Kawagoe-shi (JP)

(21) Appl. No.: 14/019,130

(22) Filed: Sep. 5, 2013

(30) Foreign Application Priority Data
Sep. 6, 2012 (JP) 2012-195827
Jun. 4, 2013 (JP) 2013-125284

(51) Int. Cl. H01F 3/08

(52) U.S. Cl. CPC H01F 3/08
USPC 336/175

(57) ABSTRACT

[TECHNICAL PROBLEM]

The present invention provides a surface-mount inductor allowing the Q to be improved at a higher frequency and preventing the efficiency of the inductor from getting worse even at the higher frequency.

[SOLUTION TO THE PROBLEM]

A surface-mount inductor comprises: a coil formed by winding a conductive wire; and a core containing the coil and formed by subjecting a mixture of a magnetic powder and a binder to powder-compacting. The magnetic powder contains plural types of magnetic powders each having a different particle size from the other, and the plural types of magnetic powders are mixed to satisfy the following relationship: Σan·Φn≦10 μm, where an is a mixing ratio, Φn is an average particle size, and n is an integer of 2 or more.

### TECHNICAL FIELD

The present invention relates to a surface-mount inductor comprising: a coil formed by winding a conductive wire; and a core formed by subjecting a mixture of a magnetic powder and a binder to powder-compacting and containing the coil therein.

### BACKGROUND ART

A conventional surface-mount inductor includes a type, as illustrated in FIG. 2, which is obtained by: winding a conductive wire to form a coil 41; and forming a core 42 while allowing the coil 41 to be incorporated therein, through powder-compacting by pressurizing a metal magnetic powder to which a binder is added, at about 2 to 5 t/cm². External terminals 43 are formed on the surface of the core 42, and the coil 41 is connected between the external terminals 43.

Since this type of surface-mount inductor uses a metal magnetic material, the coil can be disposed in a high magnetic permeability material to have an improved DC superimposition characteristic. Therefore, this type of surface-mount inductor is used, for example, for an inductor or a transformer for a power circuit or a DC/DC converter through which a large electric current flows.

### LIST OF PRIOR ART DOCUMENTS

### Patent Documents

Patent Document 1: JP 2004-153068A

### SUMMARY OF THE INVENTION

### Technical Problem

In recent years, in a power circuit or a DC/DC converter circuit for which this type of surface-mount inductor is used, an operation signal tends to have higher frequency from 1-4 MHz at present to 6-10 MHz.

In such a situation, there is a problem with the conventional surface-mount inductor that a frequency at which Q of the metal magnetic material reaches a peak is no more than 0.5 MHz, and efficiency of the inductor becomes worse when the frequency exceeds 1 MHz.

It is therefore an object of the present invention to provide a surface-mount inductor allowing the Q to be improved at a higher frequency and preventing the efficiency of the inductor from getting worse even at the higher frequency.

### Solution to the Problem

The present invention provides a surface-mount inductor comprising: a coil formed by winding a conductive wire; and a core containing the coil and formed by subjecting a mixture of a magnetic powder and a binder to powder-compacting, wherein the magnetic powder contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more.

The present invention also provides a surface-mount inductor comprising: a coil formed by winding a conductive wire; and a core containing the coil and formed by subjecting a mixture of a magnetic powder and a binder to powder-compacting, wherein the magnetic powder contains two types of magnetic powders each having a different particle size from the other, and the two types of magnetic powders are mixed to satisfy the following relationship: a×Φ1+(1−a)×Φ2 ≦10 μm, where Φ1 is a particle size of a first magnetic powder, Φ2 is a particle size of a second magnetic powder, and a is a mixing ratio.

### Effect of the Invention

According to the surface-mount inductor of the present invention, the magnetic powder constituting a core containing a coil contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more. This makes it possible to allow Q to be improved at a higher frequency and prevent the efficiency of the inductor from getting worse even at the higher frequency.

Further, according to the surface-mount inductor of the present invention, the magnetic powder constituting a core containing a coil contains two types of magnetic powders each having a different particle size from the other, and the two types of magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio. This makes it possible to allow Q to be improved at a higher frequency and prevent the efficiency of the inductor from getting worse even at the higher frequency.

### BRIEF DESCRIPTION OF THE DRAWINGS

FIG. 1 is a perspective view illustrating an embodiment of a surface-mount inductor according to the present invention.

FIG. 2 is a perspective view illustrating a conventional surface-mount inductor.

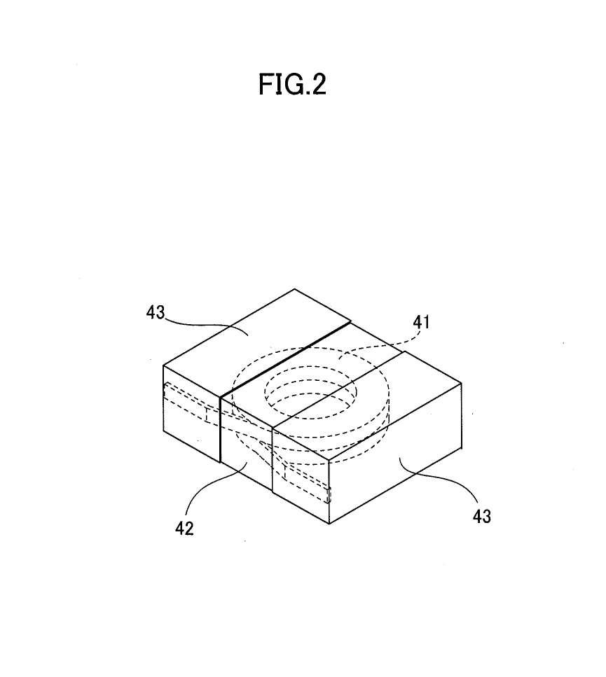

### DESCRIPTION OF EMBODIMENTS

A surface-mount inductor of the present invention comprises: a coil formed by winding a conductive wire; and a core formed by subjecting a mixture of a magnetic powder and a binder to powder-compacting and containing the coil therein. The magnetic powder contains two types of metal magnetic powders each having a different particle size from the other. The two types of metal magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio.

Thus, this surface-mount inductor makes it possible to allow a frequency at which Q of the metal magnetic material reaches a peak to be shifted to the higher frequency side and also allow an AC resistance to be decreased, without reducing magnetic permeability.

### Embodiment

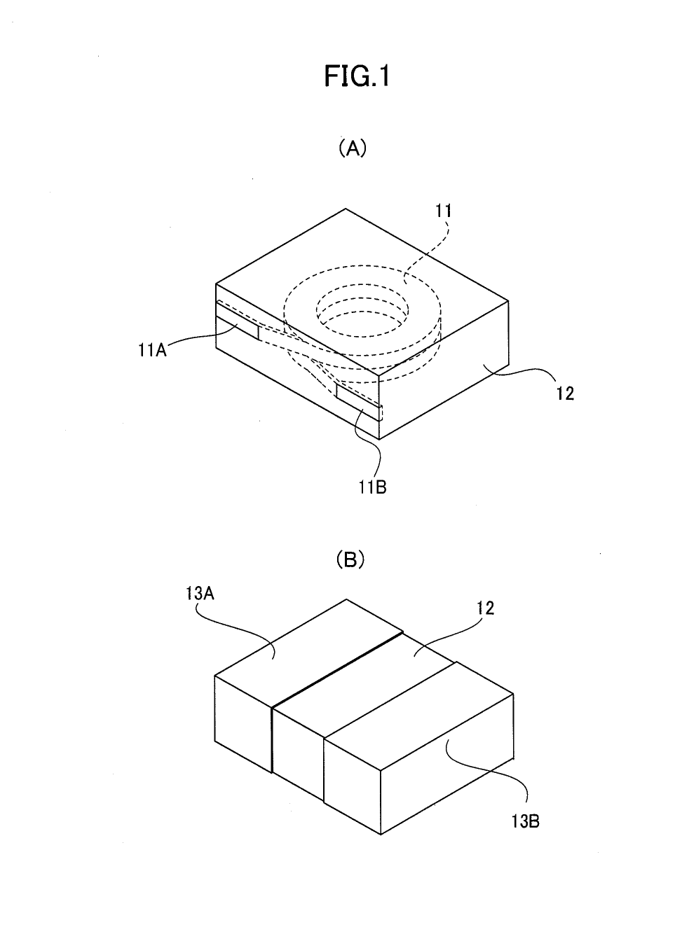

An embodiment of the surface-mount inductor according to the present invention will now be described with reference to FIG. 1.

FIG. 1 is a perspective view illustrating an embodiment of a surface-mount inductor according to the present invention.

In FIG. 1, the reference numeral 11 designates a coil, and 12 designates a core.

The coil 11 is formed by using an rectangular wire applied with an insulating coating and winding it in two-tiered outward spiral pattern to allow its opposite ends 11A, 11B to be positioned on an outer periphery.

The core 12 is formed by subjecting a composite material containing two types of metal magnetic powders each having a different particle size from the other to which a resin is added as a binder to pressurization and powder-compacting, with the coil 11 incorporated therein. The two types of metal magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio. The surfaces of the opposite ends 11A, 11B of the coil 11are exposed on the same side surface of the core 12. From the surfaces of the opposite ends 11A, 11B of the coil 11 exposed on the side surface of the core 12, the insulating coating is stripped to allow an electrical conductor to be exposed.

Then, external electrodes 13A, 13B are formed on end surfaces and four side surfaces of the core 12. The external electrode 13A and the end 11A of the coil 11, as well as the external electrode 13B and the end 11B of the coil 11 are connected respectively, to connect the coil 11 between the external electrodes 13A and 13B.

This surface-mount inductor is produced in the following manner. Firstly, the coil 11 is disposed in a mold.

Then, a composite material containing mainly two types of silicon chrome alloy powders each having a different particle size from the other to which a resin is added as a binder is filled in the mold having the coil 11 disposed therein, wherein the two types of silicon chrome alloy powders are mixed to satisfy the following relationship: a×Φ1+(1−a)×Φ2≦10 μm, where Φ1 is a particle size of a first silicon chrome alloy powder, Φ2 is a particle size of a second silicon chrome alloy powder, and a is a mixing ratio.

Subsequently, the composite material and the binder filled in the mold are subjected to pressurization and powder-compacting by the mold to form the core 12 containing the coil 11.

Further, the core 12 containing the coil 11 placed in the mold is ejected and an electrically-conductive paste is applied on the end surfaces and four side surfaces of the core 12 to form the external electrodes 13A, 13B.

In this surface-mount inductor, when a silicon chrome alloy powder having a particle size of 23 μm and a magnetic permeability of 27.2 and a silicon chrome alloy powder having a particle size of 5 μm and a magnetic permeability of 19.5 were used for the magnetic powder constituting the core and the ratio thereof was changed, then a magnetic permeability, an average particle size, and a frequency at which Q reaches a peak were altered as illustrated in Table 1.

TABLE 1

| | | Average particle | Frequency at which Q |
|---|---|---|---|
| Ratio | μ | size (μm) | reaches a peak (MHz) |
| 10:0 | 27.2 | 23 | 0.5 |
| 8:2 | 27.1 | 19.4 | 0.5 |
| 7:3 | 28.2 | 17.6 | 0.5 |
| 5:5 | 25.8 | 14 | 0.5 |
| 3:7 | 23.4 | 10 | 1 |
| 0:10 | 19.5 | 5 | 3 |

In this surface-mount inductor, when the above silicon chrome alloy powders were mixed to satisfy the following relationship: a×Φ1+(1−a)×Φ2≦10 μm, where Φ1 is a particle size of a first silicon chrome alloy powder, Φ2 is a particle size of a second silicon chrome alloy powder, and a is a mixing ratio, then the frequency at which Q reaches a peak could be 1 MHz or more relative to the fact that in the conventional surface-mount inductor, the average particle size was 15 μm and the frequency at which Q reaches a peak was 0.7 MHz.

Thus, this surface-mount inductor could achieve a higher frequency at which Q reaches a peak without decreasing the magnetic permeability by mixing the first and the second silicon chrome alloy powders to satisfy the following relationship: a×Φ1+(1−a)×Φ2≦10 μm, where Φ1 is a particle size of the first silicon chrome alloy powder, Φ2 is a particle size of the second silicon chrome alloy powder, and a is a mixing ratio.

This surface-mount inductor may also be produced in the following manner. Firstly, the coil 11 is disposed in a mold.

Then, a composite material containing mainly two types of amorphous alloy powders each having a different particle size from the other to which a resin is added as a binder is filled in the mold having the coil 11 disposed therein, wherein the two types of amorphous alloy powders are mixed to satisfy the following relationship: a×Φ1+(1−a)×Φ2≦10 μm, where Φ1 is a particle size of a first amorphous alloy powder, Φ2 is a particle size of a second amorphous alloy powder, and a is a mixing ratio.

Subsequently, the composite material and the binder filled in the mold are subjected to pressurization and powder-compacting by the mold to form the core 12 containing the coil 11.

Further, the core 12 containing the coil 11 placed in the mold is ejected and an electrically-conductive paste is applied on the end surfaces and four side surfaces of the core 12 to form the external electrodes 13A, 13B.

In this surface-mount inductor, when an amorphous alloy powder having a particle size of 10 μm and a magnetic permeability of 15.6 and an amorphous alloy powder having a particle size of 5 μm and a magnetic permeability of 10.1 were used for the magnetic powder constituting the core and the ratio thereof was changed, then a magnetic permeability, an average particle size, and a frequency at which Q reaches a peak were altered as illustrated in Table 2.

TABLE 2

| | | Average particle | Frequency at which Q |
|---|---|---|---|
| Ratio | μ | size (μm) | reaches a peak (MHz) |
| 10:0 | 15.6 | 10 | 1.6 |
| 8:2 | 15.8 | 9 | 1.7 |
| 7:3 | 15.4 | 8.5 | 1.8 |
| 6:4 | 15 | 8 | 1.9 |
| 5:5 | 14.5 | 7.5 | 2 |
| 0:10 | 10.1 | 5 | 3.5 |

In this surface-mount inductor, when the above amorphous alloy powders were mixed to satisfy the following relationship: a×Φ1+(1−a)×Φ2≦10 μm, where Φ1 is a particle size of a first amorphous alloy powder, Φ2 is a particle size of a second amorphous alloy powder, and a is a mixing ratio, then the frequency at which Q reaches a peak could be 1 MHz or more.

Thus, this surface-mount inductor could achieve a higher frequency at which Q reaches a peak without decreasing the magnetic permeability by mixing the first and the second amorphous alloy powders to satisfy the following relationship: a×1+(1−a)×Φ2≦10 μm, where Φ1 is a particle size of the first amorphous alloy powder, Φ2 is a particle size of the second amorphous alloy powder, and a is a mixing ratio.

While an embodiment of a method of producing a surface-mount inductor according to the present invention has been described above, the invention is not limited to this embodiment. For example, a use case of two types of metal magnetic powders are described in the above embodiment. Alternatively, three types or more of metal magnetic powders may be applicable. In this case, plural types of magnetic powders are mixed to satisfy the following relationship: Σan·Φn≦10 μm, where an is a mixing ratio, Φn is an average particle size, and n is an integer of 2 or more.

Further, magnetic powders with different magnetic permeabilities may be used as the plural types of magnetic powders.

### EXPLANATION OF CODES

11: coil

12: core

What is claimed is:

1. A surface-mount inductor comprising: a coil formed by winding a conductive wire; and a core containing the coil and formed by subjecting a mixture of a magnetic powder and a binder to powder-compacting,
wherein the magnetic powder contains plural types of magnetic powders each having a different particle size from others, and the plural types of magnetic powders are mixed to satisfy the following relationship: Σan·Φn≦10 μm, where an is a mixing ratio, Φn is an average particle size, and n is an integer of 2 or more.

2. A surface-mount inductor comprising: a coil formed by winding a conductive wire; and a core containing the coil and formed by subjecting a mixture of a magnetic powder and a binder to powder-compacting,
wherein the magnetic powder contains two types of magnetic powders each having a different particle size from the other, and the two types of magnetic powders are mixed to satisfy the following relationship: a×Φ1+(1−a)×Φ2≦10 μm, where Φ1 is a particle size of a first magnetic powder, Φ2 is a particle size of a second magnetic powder, and a is a mixing ratio.

3. The surface-mount inductor as defined in claim 2, wherein the magnetic powder is a metal magnetic alloy containing silicon and chrome.

4. The surface-mount inductor as defined in claim 2, wherein the magnetic powder is an amorphous alloy.
